(19) United States
(12) Patent Application Publication
(10) Pub. No.: US 2019/0042770 A1
(43) Pub. Date: Feb. 7, 2019

(54) SYSTEMS AND METHODS FOR ATTACHED DIGITAL STORAGE DEVICES

(71) Applicant: Robert H. Thibadeau, SR., Pittsburgh, PA (US)

(72) Inventor: Robert H. Thibadeau, SR., Pittsburgh, PA (US)

(73) Assignee: Antique Books, Inc., Pittsburgh, PA (US)

(21) Appl. No.: 16/053,516

(22) Filed: Aug. 2, 2018

Related U.S. Application Data
(60) Provisional application No. 62/540,167, filed on Aug. 2, 2017.

(51) Int. Cl. G06F 21/60; G06F 12/14; G06F 21/62; G06F 21/79; G06F 3/06

(52) U.S. Cl. CPC G06F 21/604; G06F 12/1408; G06F 12/1441; G06F 21/6218; G06F 21/79; G06F 2221/2141; G06F 3/062; G06F 3/0637; G06F 3/067; G06F 2212/402; G06F 2212/1052; G06F 3/0604

(57) ABSTRACT

Systems and methods for attached digital storage devices are provided. In some embodiments, a method of operation of a storage device includes receiving a request from a client device by a user for an interaction with the storage device; performing advanced capabilities testing on the user based on the interaction; and based on the advanced capabilities testing, permitting the user to complete the interaction with the storage device. In this way, the utility of the storage device is increased in new ways.

### RELATED APPLICATIONS

This application claims the benefit of provisional patent application Ser. No. 62/540,167, filed Aug. 2, 2017, the disclosure of which is hereby incorporated herein by reference in its entirety.

### FIELD OF THE DISCLOSURE

The present disclosure relates to managing storage devices.

### BACKGROUND

Attached Digital Storage Devices (ADSDs) are a common commodity commercially seen as Flash Drives, Thumb Drives, SD Cards, Solid State USB/M2 Drives, Rotating Media USB/M2 Hard Drives, Network Attached Storage (NAS), and most compute servers assume storage devices are readily attached to the server configuration, either standalone as SANs or integrated into the compute servers. The particular attachment method can be a basic logical storage interface such as SAS, SATA, NVMe, or UFS along with a variety of physical interfaces to facilitate plugging in and out or attaching and detaching the storage devices.

Converging with this diverse assortment of ADSDs has been recent advancements in self-protecting storage wherein the storage devices themselves encrypt data to protect data against theft by simply walking away with the ADSDs. These ADSDs are generically termed “self-encrypting drives” (SEDs). (See US Patents U.S. Pat. No. 7,036,020, U.S. Pat. No. 7,360,057, and U.S. Pat. No. 7,426,747).

Today nearly all cloud ADSDs are self-encrypting and cryptographically paired with the server equipment to mitigate against the possibility of sensitive data being obtained from decommissioned, repurposed, or otherwise lost ADSDs. Most all office printers also pair their SEDs with the printers. The industry standard logical interface to SEDs is provided by the Trusted Computing Group (TCG, www.trustedcomputinggroup.org). These standards dominate the commodity markets for SEDs. Microsoft Bitlocker can detect a TCG SED and offer to provide Bitlocker encryption using the SED capability of one or more ADSDs attached to the host computer.

Secondary, less capable industry standards involve small additions to existing ADSD interfaces (e.g., the SATA Security Lock and Unlock commands extended to control the self-encrypting hardware built into the ADSDs.) Unfortunately these extremely simple use cases (singular host device—SED pairing), while highly successful in the global marketplace for certain restricted uses, has failed to provide devices with wider ranges of use anticipated by TCG. Just as paper has many uses depending on how it is manufactured and presented to the consumer as a solution to different problems (e.g., patents on types of paper, systems of paper such as filters, folding systems, and the like), a method and system is needed to provided additional types of SEDs despite using standard components in product already in the market. The TCG Core, Opal, Enterprise, and SiiS specifications are incorporated by reference to constitute this standard basic component.

### SUMMARY

Systems and methods for attached digital storage devices are provided. In some embodiments, a method of operation of a storage device includes receiving a request from a client device by a user for an interaction with the storage device; performing advanced capabilities testing on the user based on the interaction; and based on the advanced capabilities testing, permitting the user to complete the interaction with the storage device. In this way, the utility of the storage device is increased in new ways.

In some embodiments, performing advanced capabilities testing on the user based on the interaction comprises providing an IT management multiuser system. In some embodiments, providing the IT management multiuser system comprises providing central auditing and management for the storage device.

In some embodiments, performing advanced capabilities testing on the user based on the interaction comprises providing a family multiuser system. In some embodiments, providing the family multiuser system comprises remotely controlling the storage device should the storage device be lost or stolen.

In some embodiments, performing advanced capabilities testing on the user based on the interaction comprises providing an archive multiuser read-only system. In some embodiments, providing the archive multiuser read-only system comprises managing an archive and then providing read-only access to one or more parts of the archive to one or more users. In some embodiments, providing the archive multiuser read-only system comprises providing an archive hierarchy where all users gain read-only to a first portion of the storage device but some users gain access to only restricted parts of the archive. In some embodiments, the first portion of the storage device is the whole storage device.

In some embodiments, performing advanced capabilities testing on the user based on the interaction comprises providing a forensic multiuser read-only system. In some embodiments, providing the forensic multiuser read-only system comprises managing forensic copies of other storage devices that can be distributed as self-protecting read-only copies.

In some embodiments, the storage device is a self-encrypting drive. In some embodiments, the storage device is one of the group consisting of an entire storage drive, a partition of a storage drive, a file, a storage object, and a document.

In some embodiments, a storage device includes a data storage; and circuitry. The circuitry is configured to receive a request from a client device by a user for an interaction with the storage device; perform advanced capabilities testing on the user based on the interaction; and based on the advanced capabilities testing, permit the user to complete the interaction with the storage device.

Some embodiments of the present disclosure involve taking the configurable SED hardware as defined by TCG and efficiently creating at least three new and unique SED categories. These categories are different unique hardware/software methods and systems that provide unique design, cost, manufacturability, and support efficiencies. Furthermore, the three new and unique SED systems can be expanded to five types of SED systems, each of which can incorporate new methods to create five distinct types of SED systems. Four of these five types of SED systems are new and unique to the user. All five combine the industry standard components in new and unique ways. We further teach that this basic methodology of providing incremental improvements to a generic SED product provides a new realm of invention and improvements to ADSDs.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a host computer or client device attached to a storage device according to some embodiments of the present disclosure;

FIG. 2 illustrates the components of a storage device according to some embodiments of the present disclosure;

FIG. 3 illustrates additional components and methods of a storage device according to some embodiments of the present disclosure;

FIG. 4 illustrates a method of operation of a storage device according to some embodiments of the present disclosure;

FIG. 5 is a schematic block diagram of a computation node according to some embodiments of the present disclosure;

FIG. 6 is a schematic block diagram that illustrates a virtualized embodiment of the computation node of FIG. 5 according to some embodiments of the present disclosure; and

FIG. 7 is a schematic block diagram of the computation node of FIG. 5 according to some other embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

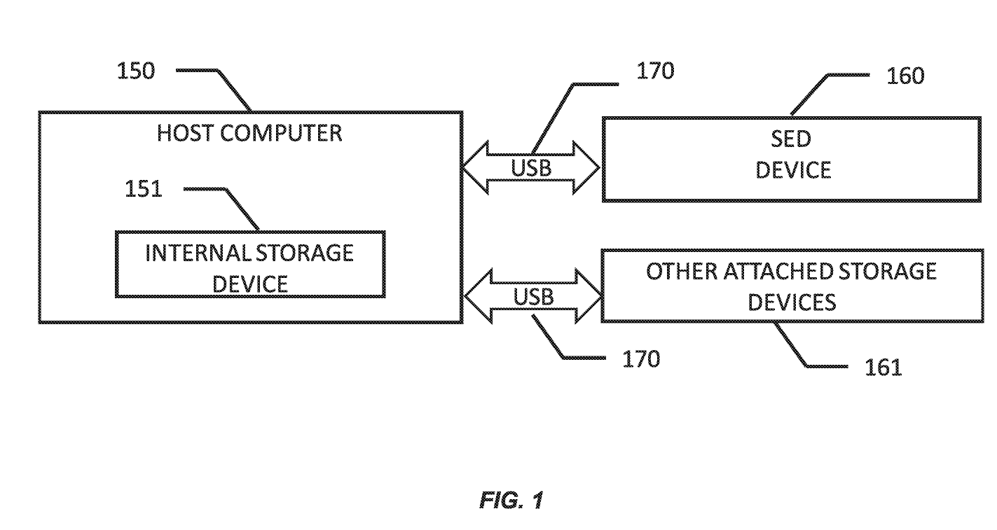

FIG. 1 shows that in routine use, the host computer in operation 150 with its own internal storage in operation 151 is attached to a TCG SED drive in operation 160 via a USB storage interface in operation 170 (or other well-defined storage device attachment interface including but not limited to PCIe, M.2, SATA, SAS). Other attached storage devices, including network attached devices, in operation 161 may be attached to the host computer by way of the same or similar storage interfaces.

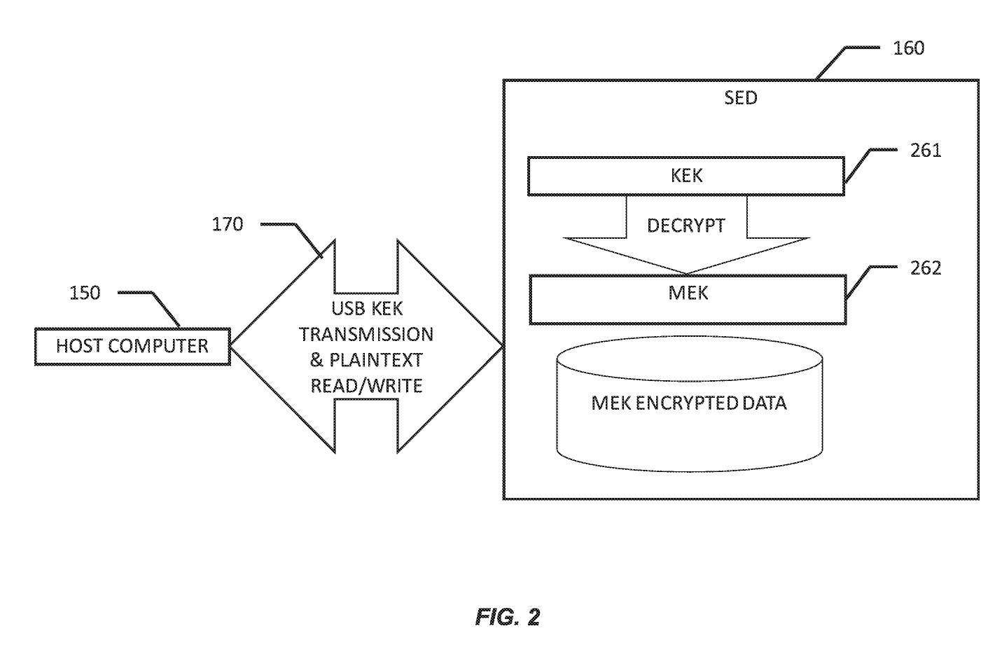

FIG. 2 shows that to be an SED, an ADSD must be improved with encryption circuitry and a means of providing at least one Key Encryption Key (KEK) in Operation 261 to unlock at least one Media Encryption Key (MEK) in Operation 262 for the encryption/decryption of data. Data coming over the ADSD logical interface is always plaintext. The encryption circuitry makes sure that the actual nonvolatile storage of the data is encrypted.

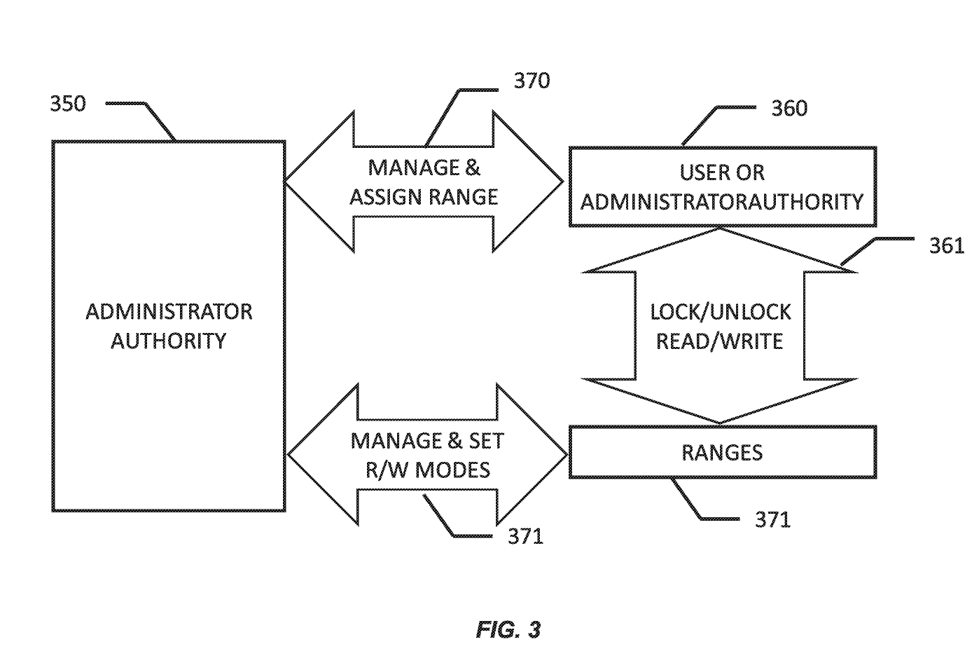

FIG. 3 shows that for TCG SEDs the specifications allow more than one KEK. In particular, there can be a specified number of KEKs of two types, Administrator and User KEKs in Operations 350 and 360. The Administrator can Manage and Assign Ranges in operation 370 and can Manage and Set R/W Modes over Ranges in 371. The TCG specifications allow more than one encrypting partition, or range in operation 361, each with its own MEK, and different KEKs for different Administrator and Users can be associated with different MEKs associated with the different storage ranges inside the SED as determined by the Administrator managing the Lock/Unlock and Read/Write operations in 361.

The dominant use of SEDs in cloud storage pairing, printer storage pairing, and Microsoft B361itlocker uses only the most primitive configuration possible: one KEK and one MEK for the entire storage device. This single KEK-MEK is also what appears in proprietary SEDs, such as Western Digital Hardware Encrypting USB drives, as one example. Similarly, a single KEK-MEK solution is provided using the open TCG standard ADSDs through USB or similar attached storage interfaces. This configuration will be referred to as a Basic Configuration. To the end user this basic configuration is not novel nor unique, but how it operates is, in service to the advantages above.

The Basic System Configuration mimics existing USB hardware encrypting ADSDs but employs industry standard TCG SEDs. It contains one unique method to provide this unique mimicry. FIG. 3 shows this method. On a TCG SED there are two types of Administrator credential. One is associated with control of the SED device itself and one is associated with locking/encryption. The Basic Configuration sets both these administrators to exactly the same credential to become the one password that works to achieve mimicry of existing USB hardware encrypting devices. No use is made of the user credential capability of the TCG drives. It is important to note that this basic configuration provides full read/write access to the entirety of user space on the SED.

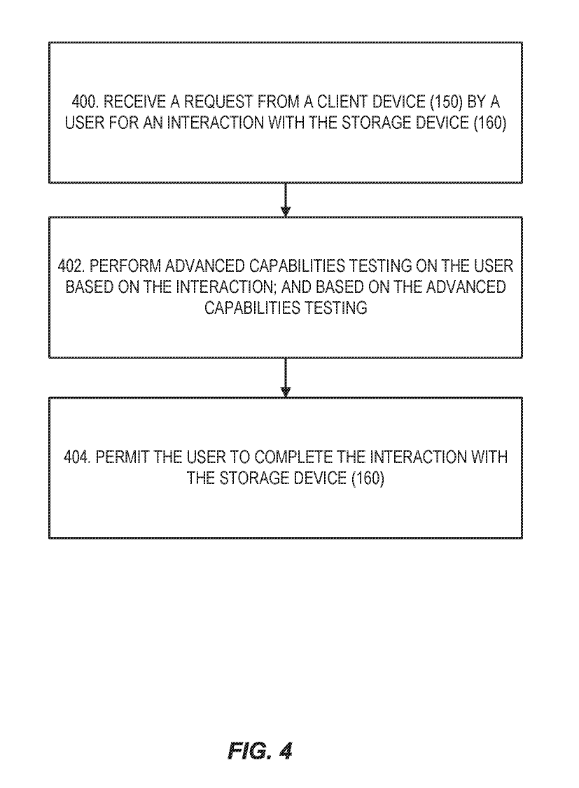

Systems and methods for attached digital storage devices are provided. FIG. 4 illustrates a method of a method of operation of a storage device according to some embodiments of the present disclosure. In some embodiments, a method of operation of a storage device (160) includes receiving (400) a request from a client device (150) by a user for an interaction with the storage device (160); performing (402) advanced capabilities testing on the user based on the interaction; and based on the advanced capabilities testing, permitting (404) the user to complete the interaction with the storage device (160). In this way, the utility of the storage device (160) is increased in new ways.

The other four systems are first divided into two additional system types based on the addition of other unique methods. These additional system types will be referred to as Multiuser Access and Multiuser Read-Only Access.

The Multiuser Access System adds one new method on the Basic Method. The doublet initial (Device and Locking Administrator) credential can create a number of user credentials. In the preferred embodiment this number is 8. Each user has a distinct credential, and distinct from the Administrator credential, so that the SED can be shared for READ/WRITE access data on the drive with the Administrator alone capable of creating initial users and credentials, cryptographically erasing the data on the drive, and changing its own credentials. Users can only change their own credentials, but can also unlock the SED for reading and writing.

Optionally, the Multiuser Access System can exploit the encrypting range capability of TCG SEDs. The Basic Administrator credential is one authorizing KEK over all the ranges. However, the Basic Administrator can also assign different users to different encrypting ranges. Thus different users can unlock only ranges that contain data they are by policy admitted to Read and Write.

The Multiuser Read-Only Access System similarly provides a number of other users access to data on the drive, but these users are not able to write any data to the SED. This is not configurable by the system. The users can change their own credentials, but users can only read data that has been written by the drive administrator.

The optional encrypting ranges now apply to these users as before. The administrator can now configure the SED to provide different read-only data for different users.

Each of the multiuser Systems can be further improved with additional methods unique to the following four system types. These are briefly defined below:

IT Management (Multiuser): This adds IT management methods to the Multiuser System. For example, it can provide central auditing and management to the SEDs. In some embodiments, performing advanced capabilities testing on the user based on the interaction comprises providing an IT management multiuser system. In some embodiments, providing the IT management multiuser system comprises providing central auditing and management for the storage device (160).

Family (Multiuser): This adds family specific management methods to the Multiuser System. For example, parents may provide drives that they can remotely control should a child's SED be lost or stolen. In some embodiments, performing advanced capabilities testing on the user based on the interaction comprises providing a family multiuser system. In some embodiments, providing the family multiuser system comprises remotely controlling the storage device (160) should the storage device (160) be lost or stolen.

Archive (Multiuser Read-Only): This adds methods for managing an archive and then providing read-only access to one or more parts of the archive to one or more users. The archive method can provide, as one new method, a means to provide an archive hierarchy where all users gain read-only to, for example, the whole drive, but some users gain access to only restricted parts of the archive. In some embodiments, performing advanced capabilities testing on the user based on the interaction comprises providing an archive multiuser read-only system. In some embodiments, providing the archive multiuser read-only system comprises managing an archive and then providing read-only access to one or more parts of the archive to one or more users. In some embodiments, providing the archive multiuser read-only system comprises providing an archive hierarchy where all users gain read-only to a first portion of the storage device (160) but some users gain access to only restricted parts of the archive. In some embodiments, the first portion of the storage device (160) is the whole storage device (160).

Forensic (Multiuser Read-Only): This adds methods for managing forensic copies of other storage devices that can be distributed as self-protecting read-only copies. The additional methods include resources for remote enablement. For example, this drive can be purchased anywhere and configured and loaded securely by the agent over the WAN while the purchaser of the drive only has read-only access for the purposes of control of digital evidence. In some embodiments, performing advanced capabilities testing on the user based on the interaction comprises providing a forensic multiuser read-only system. In some embodiments, providing the forensic multiuser read-only system comprises managing forensic copies of other storage devices that can be distributed as self-protecting read-only copies.

Finally, with a cryptoerase of the SED as defined in TCG specifications, any of the above five drive systems above can be now configured using the basic SED hardware and the appropriately selected software. This is an advantage if a specific attached storage device needs to be redeployed as one of the other exclusive systems.

Just as paper has a raw basic form but many patented system forms based on the additions of unique methods for not yet understood forms, the basic TCG SED (and proprietary SEDs with the same capabilities) can be put into systems which define novel methods and thus increase the utility of the original SEDs in new ways.

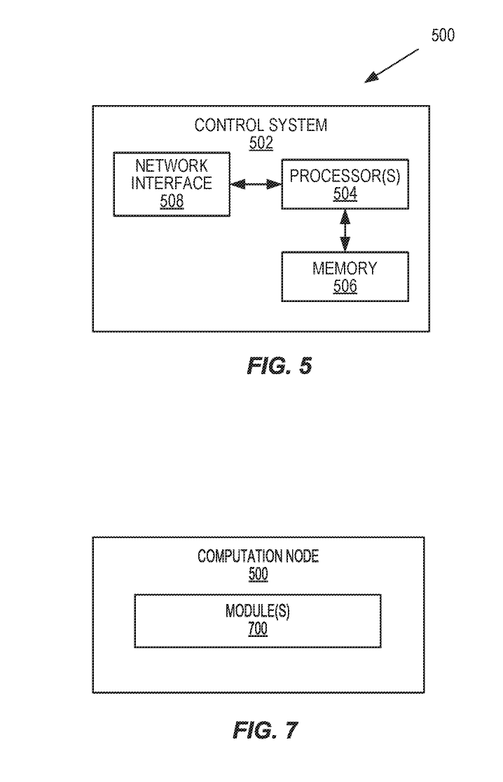

FIG. 5 is a schematic block diagram of a computation node 500 according to some embodiments of the present disclosure. The computation node 500 may be, for example, a host computer 150, a SED device 160, or another attached storage device 161. As illustrated, the computation node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of a computation node 500 as described herein. In some embodiments, the function(s) are implemented in software that is stored, e.g., in the memory 506 and executed by the one or more processors 504.

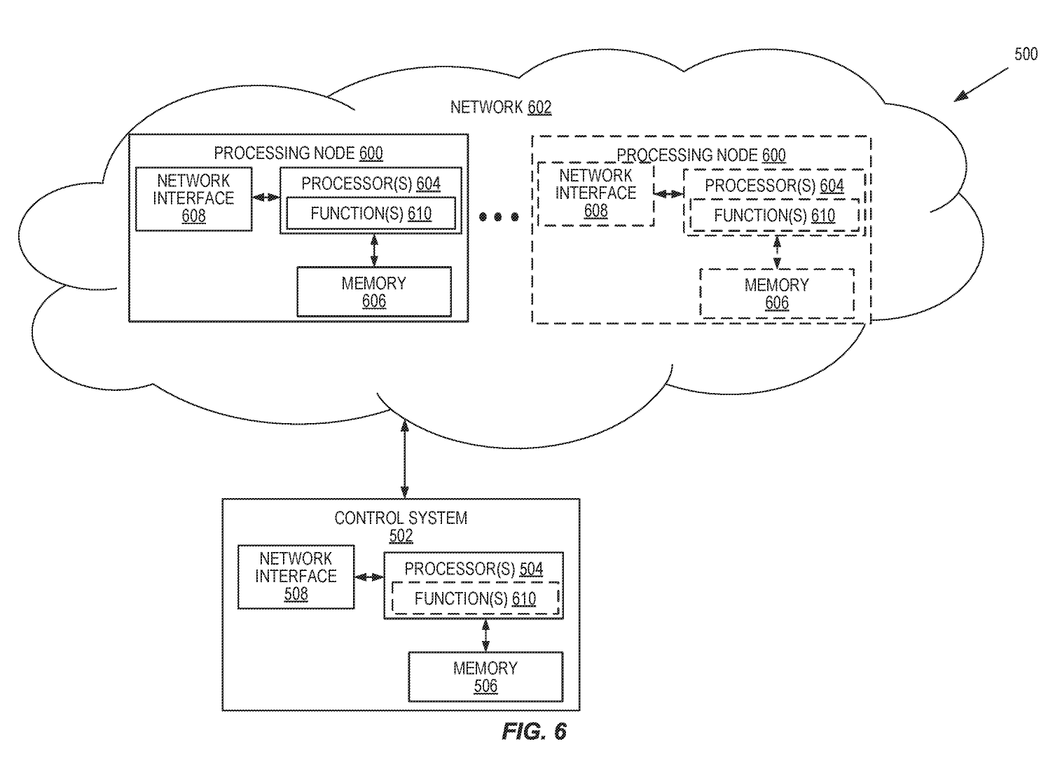

FIG. 6 is a schematic block diagram that illustrates a virtualized embodiment of the computation node 500 according to some embodiments of the present disclosure. This discussion is equally applicable to other types of network nodes. Further, other types of compute nodes may have similar virtualized architectures.

As used herein, a “virtualized” computation node is an implementation of the computation node 500 in which at least a portion of the functionality of the computation node 500 is implemented as a virtual component(s) (e.g., via a virtual machine(s) executing on a physical processing node(s) in a network(s)). As illustrated, in this example, the computation node 500 includes the control system 502 that includes the one or more processors 504 (e.g., CPUs, ASICs, FPGAs, and/or the like), the memory 506, and the network interface 508. The control system 502 is connected to one or more processing nodes 600 coupled to or included as part of a network(s) 602 via the network interface 508. Each processing node 600 includes one or more processors 604 (e.g., CPUs, ASICs, FPGAs, and/or the like), memory 606, and a network interface 608.

In this example, functions 610 of the computation node 500 described herein are implemented at the one or more processing nodes 600 or distributed across the control system 502 and the one or more processing nodes 600 in any desired manner. In some particular embodiments, some or all of the functions 610 of the computation node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610.

In some embodiments, a computer program including instructions which, when executed by at least one processor, causes the at least one processor to carry out the functionality of computation node 500 or a node (e.g., a processing node 600) implementing one or more of the functions 610 of the computation node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the computation node 500 according to some other embodiments of the present disclosure. The computation node 500 includes one or more modules 700, each of which is implemented in software. The module(s) 700 provide the functionality of the computation node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the preferred embodiments of the present disclosure. All such improvements and modifications are considered within the scope of the concepts disclosed herein and the claims that follow.

What is claimed is:

1. A method of operation of a storage device, (160), comprising:
receiving (400) a request from a client device (150) by a user for an interaction with the storage device (160);
performing (402) advanced capabilities testing on the user based on the interaction; and
based on the advanced capabilities testing, permitting (404) the user to complete the interaction with the storage device (160).

2. The method of claim 1 wherein performing the advanced capabilities testing on the user based on the interaction comprises providing an IT management multiuser system.

3. The method of claim 2 wherein providing the IT management multiuser system comprises providing central auditing and management for the storage device (160).

4. The method of claim 1 wherein performing the advanced capabilities testing on the user based on the interaction comprises providing a family multiuser system.

5. The method of claim 4 wherein providing the family multiuser system comprises remotely controlling the storage device (160) should the storage device (160) be lost or stolen.

6. The method of claim 1 wherein performing the advanced capabilities testing on the user based on the interaction comprises providing an archive multiuser read-only system.

7. The method of claim 6 wherein providing the archive multiuser read-only system comprises managing an archive and then providing read-only access to one or more parts of the archive to one or more users.

8. The method of claim 6 wherein providing the archive multiuser read-only system comprises providing an archive hierarchy where all users gain read-only to a first portion of the storage device (160) but some users gain access to only restricted parts of the archive.

9. The method of claim 8 wherein the first portion of the storage device (160) is a whole storage device (160).

10. The method of claim 1 wherein performing the advanced capabilities testing on the user based on the interaction comprises providing a forensic multiuser read-only system.

11. The method of claim 10 wherein providing the forensic multiuser read-only system comprises managing forensic copies of other storage devices that can be distributed as self-protecting read-only copies.

12. The method of claim 1 wherein the storage device (160) is a self-encrypting drive.

13. The method of claim 1 wherein the storage device is one of the group consisting of an entire storage drive, a partition of a storage drive, a file, a storage object, and a document.

14. A storage device (160) comprising:
a data storage; and
circuitry configured to:
receive a request from a client device (150) by a user for an interaction with the storage device (160);
perform advanced capabilities testing on the user based on the interaction; and
based on the advanced capabilities testing, permit the user to complete the interaction with the storage device (160).

15. The storage device (160) of claim 14 wherein performing the advanced capabilities testing on the user based on the interaction comprises providing an IT management multiuser system.

16. The storage device (160) of claim 15 wherein providing the IT management multiuser system comprises providing central auditing and management for the storage device (160).

17. The storage device (160) of claim 14 wherein performing the advanced capabilities testing on the user based on the interaction comprises providing a family multiuser system.

18. The storage device (160) of claim 17 wherein providing the family multiuser system comprises remotely controlling the storage device (160) should the storage device (160) be lost or stolen.

19. The storage device (160) of claim 14 wherein performing the advanced capabilities testing on the user based on the interaction comprises providing an archive multiuser read-only system.

20. The storage device (160) of claim 19 wherein providing the archive multiuser read-only system comprises managing an archive and then providing read-only access to one or more parts of the archive to one or more users.
